(19) United States
(12) Patent Application Publication
(10) Pub. No.: US 2026/0264211 A1
(43) Pub. Date: Sep. 10, 2026

(54) HANDHELD POWER TOOL SYSTEM AND ACCESSORY BOX

(71) Applicant: Nanjing Chervon Industry Co., Ltd., Nanjing (CN)

(72) Inventors: Mingshun E, Nanjing (CN); Xue Yu, Nanjing (CN); Wendan Ma, Nanjing (CN)

(21) Appl. No.: 19/229,078

(22) Filed: Jun. 5, 2025

(30) Foreign Application Priority Data
Mar. 6, 2025 (CN) 202510265168.3

(51) Int. Cl. B25F 5/02; B25F 1/02

(52) U.S. Cl. CPC B25F 5/029; B25F 1/02

(57) ABSTRACT

A handheld power tool system includes a tool body adaptable to at least one of multiple tool accessories separately; an accessory box including a first space for receiving the tool body and a second space for storing the multiple tool accessories; and a housing having a first state in which the housing covers the second space and a second state in which the housing releases the second space. The housing includes a first panel and a second panel; and in the second state, the first panel and the second panel are capable of extending substantially coplanarly on a working plane.

### RELATED APPLICATION INFORMATION

This application claims the benefit under 35 U.S.C. § 119(a) of Chinese Patent Application No. CN 202510265168.3, filed on Mar. 6, 2025, which application is incorporated herein by reference in its entirety.

### TECHNICAL FIELD

The present application relates to power tools and, in particular, to a handheld power tool system and an accessory box.

### BACKGROUND

In the existing art, a power tool and tool accessories are typically stored separately, which occupy a relatively large storage space. During use, a user carries a tool accessory and the power tool as required. After use, the tool accessory is randomly placed and easily lost. Moreover, the randomly placed tool accessory is inconvenient for the user to take out quickly.

This part provides background information related to the present application, and the background information is not necessarily the existing art.

### SUMMARY

A handheld power tool system includes a tool body adaptable to at least one of multiple tool accessories separately; an accessory box including a first space for receiving the tool body and a second space for storing the multiple tool accessories; and a housing having a first state in which the housing covers the second space and a second state in which the housing releases the second space. The housing includes a first panel and a second panel; and in the second state, the first panel and the second panel are capable of extending substantially coplanarly on a working plane.

In some examples, in the first state, the first panel is not coplanar with the second panel.

In some examples, the first panel is integrally formed with or detachably connected to the second panel.

In some examples, at least part of the housing includes a magnetic material.

In some examples, the accessory box has a polygonal cross-section along a longitudinal direction.

In some examples, the second space includes a first portion and a second portion, and the first portion and the second portion are located on different sides of the accessory box.

In some examples, the tool body is ejectable relative to the accessory box.

In some examples, an elastic self-locking switch is provided in the second space of the accessory box, and the tool body is capable of being engaged with or disengaged from the elastic self-locking switch.

In some examples, a first engaging member is provided at an end of the tool body facing the elastic self-locking switch, a second engaging member is movably disposed on the elastic self-locking switch, and the second engaging member has a release position and an engaging position; when the second engaging member is at the engaging position, the second engaging member is engaged with the first engaging member; and when the second engaging member is at the release position, the second engaging member is disengaged from the first engaging member, and the tool body is ejectable relative to the accessory box.

In some examples, a fixed receptacle is provided in the first space of the accessory box and configured to receive a driving end of the tool body.

In some examples, the second space includes multiple independent storage regions, any one of which is capable of storing at least two of the multiple tool accessories.

In some examples, a tool accessory of the multiple tool accessories is releasably stored in any one or a particular one of the storage regions by means of magnetic fixation.

In some examples, the multiple tool accessories include a bit and an aiding tool.

In some examples, the tool body includes an electric screwdriver or an electric rotary grinder.

In some examples, measurement markings are provided on an inner surface of the housing to form a scale.

An accessory box includes a first space capable of receiving a tool body; and a second space for releasably storing multiple tool accessories adapted to the tool body. The accessory box further includes a housing including a first end having a first position and a second position, where the first end moves between the first position and the second position to substantially seal or release the second space; and at least part of the housing is magnetic.

In some examples, the housing has a second end integrally formed with or detachably connected to a body of the accessory box, and the first end is an end of the housing distal from the second end.

In some examples, the second space includes a first portion and a second portion, and the first portion and the second portion are located on different sides of the accessory box.

In some examples, the second space is disposed inside the housing.

In some examples, the second space is disposed around the first space.

A handheld power tool system includes a tool body adaptable to at least one of multiple tool accessories separately; and an accessory box including a first space for receiving the tool body and a second space for releasably storing the multiple tool accessories. The handheld power tool system further includes a housing having a first state in which the housing is bent to cover the second space and a second state in which the housing releases at least part of the second space, where at least part of the housing is capable of attracting the multiple tool accessories.

In some examples, the housing includes a first panel and a second panel, and in the second state, the first panel and the second panel are capable of extending substantially coplanarly on a working plane.

In some examples, in the first state, the first panel is not coplanar with the second panel.

In some examples, the first panel is integrally formed with or detachably connected to the second panel.

### BRIEF DESCRIPTION OF THE DRAWINGS

FIG. 1 is a schematic view of an example of the present application.

FIG. 2 is a front view of an example of the present application.

FIG. 3 is a schematic view of an example of the present application, with a housing unfolded.

FIG. 4 is a schematic view of an example of the present application, with some bits taken out.

FIG. 5 is a front view of an example of the present application, with a tool body received in a first space.

FIG. 6 is a schematic view of an example of the present application, with a tool body engaged with an elastic self-locking switch.

FIG. 7 is an exploded view of a tool body and an elastic self-locking switch according to an example of the present application.

FIG. 8 is a schematic view of an example of the present application, with a tool body in an ejected state.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

An electric motor, a working accessory, and a control board including electronic elements are generally integrated into a housing of a power tool for use. The working accessory is used for operation. In practical application, with different working accessories interchanged, the power tool may form a mower, a snow thrower, a rammer, a sprinkler truck, a pressure washer, a sawmill, and the like, which play important roles across multiple fields including gardening, building, agriculture, and daily life. Alternatively, the power tool may be a table tool, for example, a table saw, a miter saw, a circular saw, a metal cutter, a router, an edge trimmer, or a marble cutter. Alternatively, the power tool may be a grinding tool, for example, an angle grinder, a sander, or an electric rotary grinder. Alternatively, the power tool may be an electric hand drill or an impact drill, where the electric hand drill and the impact drill may be configured with drill bits of different diameters to drill holes in objects. Alternatively, the power tool may be an impact wrench for twisting bolts and nuts or an impact screwdriver that typically loosens or tightens screws.

A handheld power tool is a power tool that is driven to operate by a direct current or an alternating current. The power tool uses a rechargeable battery set as a power supply. In this example, the battery set is a battery pack, and the battery pack collaborates with a corresponding power circuit to supply power to the power tool. It is to be understood by those skilled in the art that in other examples, the power tool may be powered by another power supply device. For example, the power supply may be an alternating current wire connected to mains electricity or another connection cable connectable to power supply equipment. The corresponding components in the power tool are powered by mains electricity or another power supply equipment in conjunction with corresponding rectifier, filter, and voltage regulator circuits.

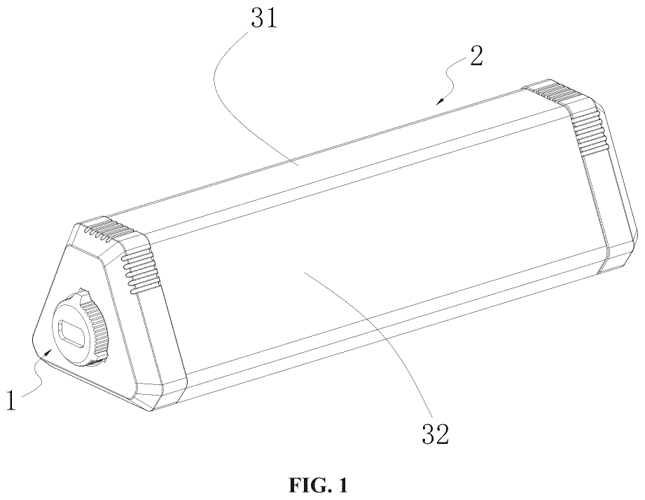

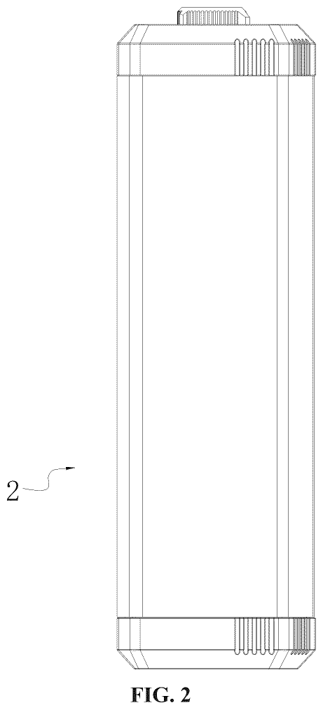

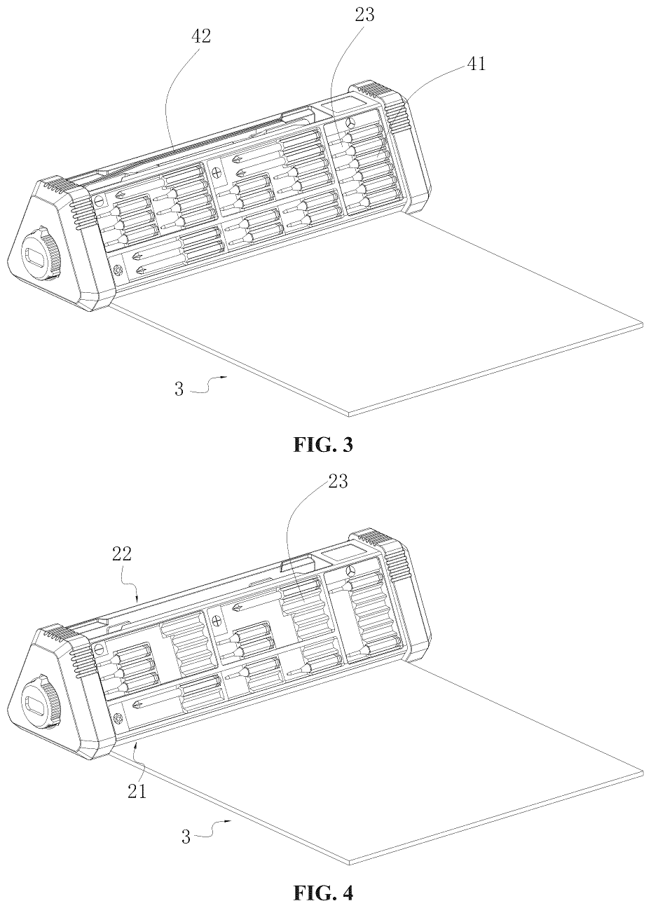

To facilitate the use and storage of the handheld power tool and tool accessories, as shown in FIGS. 1 to 8, the present application provides a handheld power tool system. The handheld power tool system includes a tool body 1, an accessory box 2, and a housing 3.

The tool body 1 is adaptable to at least one of multiple tool accessories 4 separately. The accessory box 2 includes a first space for receiving the tool body 1 and a second space for storing the multiple tool accessories 4. The housing 3 has a first state in which the housing 3 covers the second space and a second state in which the housing 3 releases the second space. The housing 3 includes a first panel 31 and a second panel 32. In the second state, the first panel 31 and the second panel 32 are capable of extending substantially coplanarly on a working plane. That the first panel 31 and the second panel 32 can be substantially coplanar means that the angle between the first panel 31 and the second panel 32 is greater than or equal to 170° and less than or equal to 180°. Specifically, the angle between the first panel 31 and the second panel 32 may be 171°, 172°, 173°, 174°, 175°, 176°, 178°, 179°, or 180°.

The accessory box 2 is used to store the tool body 1 in the first space and the tool accessories 4 in the second space, facilitating storage, reducing an occupied space, and making it convenient to subsequently configure the tool body 1 with the corresponding tool accessory 4 for use. When the handheld power tool system is not in use, the housing 3 is in the first state in which the housing 3 covers the second space so that the tool accessories 4 can be prevented from falling off. During use of a user, the housing 3 is in the second state in which the housing 3 releases the second space. The tool accessories 4 in the second space can be completely exposed as long as the first panel 31 and the second panel 32 extend on the working plane. The user can directly take the corresponding tool accessory 4 as required, facilitating the use of the user. When the tool accessory 4 is replaced, the tool accessory 4 may be placed on the unfolded first panel 31 and second panel 32. After the completion of operation, the tool accessory 4 is directly stored in the second space. Then, the housing 3 is switched from the second state to the first state. In this manner, the tool accessories 4 are prevented from being lost and convenient to store and carry.

As shown in FIG. 1, in some examples, in the first state, the first panel 31 is not coplanar with the second panel 32. When the housing 3 is in the first state, the housing 3 covers the second space, and the first panel 31 is not coplanar with the second panel 32. Thus, the housing 3 can be three-dimensional so that a combination of the accessory box 2 and the housing 3 is compact in volume and has a relatively large storage space.

In some examples, the first panel 31 is integrally formed with or detachably connected to the second panel 32. The first panel 31 is integrally formed with the second panel 32, facilitating manufacturing and achieving a stable connection between the first panel 31 and the second panel 32. If the first panel 31 is integrally formed with the second panel 32, only a fold needs to be formed at a boundary between the first panel 31 and the second panel 32. Alternatively, the first panel 31 may be detachably connected to the second panel 32 in a manner of insertion, engaging, or magnetic attraction. When detachably connected, the first panel 31 or the second panel 32 can be replaced in response to a quality problem or deformation, thereby improving economy. Moreover, the first panel 31 and the second panel 32 may have some functions customized according to actual requirements, for example, the first panel 31 is magnetic, and the second panel 32 is not magnetic. The detachable connection enables the functions of the first panel 31 and the second panel 32 to be flexibly configured.

In some examples, at least part of the housing 3 includes a magnetic material. The magnetic material is disposed so that a portion of the housing 3 provided with the magnetic material is magnetic. When the housing 3 is unfolded on the working plane in the second state, the magnetic portion may attract fasteners such as screws and bolts or temporarily attract the replaced working accessory. At least part of the housing 3 is provided with a magnet, or a portion of the housing 3 having a magnetic property is made of the magnetic material, which is not limited too much here.

As shown in FIG. 1, in some examples, the accessory box 2 has a polygonal cross-section along a longitudinal direction. The cross-section of the accessory box 2 along the longitudinal direction may be triangular, quadrangular, pentagonal, or hexagonal, which is not limited too much here. The accessory box 2 is designed to be a prism so that the second space is formed on multiple sides of the accessory box 2, the area of the second space is increased, and different types of tool accessories 4 can be placed as required.

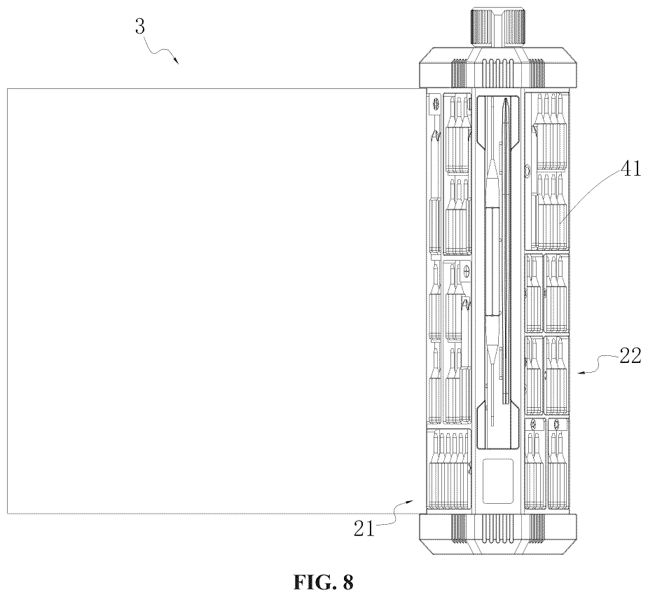

As shown in FIGS. 4 and 8, in some examples, the second space includes a first portion 21 and a second portion 22, and the first portion 21 and the second portion 22 are located on different sides of the accessory box 2. The second space is divided into the first portion 21 and the second portion 22 so that the first portion 21 and the second portion 22 form two independent spaces, making it convenient to configure different types of tool accessories 4 according to workplaces of the user and place the same type of tool accessories 4 in the same portion.

As shown in FIG. 8, in some examples, the tool body 1 is ejectable relative to the accessory box 2. When the tool body 1 is not in use, the tool body 1 is inserted into the first space. Thus, the tool body 1 and the accessory box 2 form a whole, which is convenient to carry. When the tool body 1 needs to be used, only a press on the tool body 1 is needed so that the tool body 1 can be ejected from the accessory box 2, and the user can take out the tool body 1 for use.

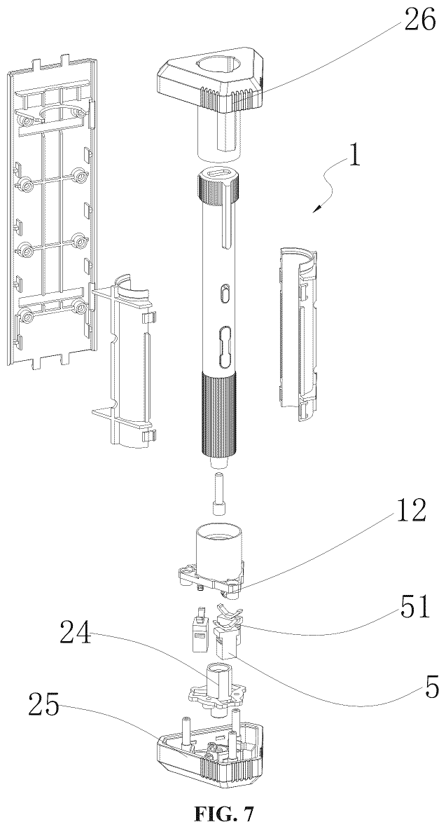

As shown in FIG. 7, in some examples, a first end cover 26 and a second end cover 25 are provided at two ends of the accessory box 2 along an axial direction of the accessory box 2, the first end cover 26 is provided with a through hole coaxially communicating with the first space, and the tool body 1 is inserted into the first space through the through hole.

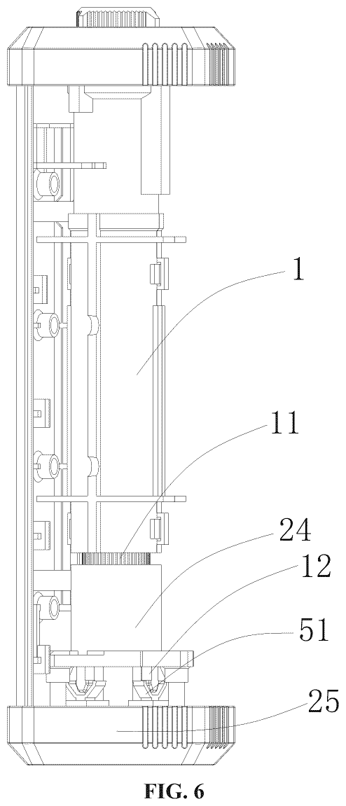

As shown in FIGS. 6 and 7, in some examples, an elastic self-locking switch 5 is provided in the first space of the accessory box 2, the elastic self-locking switch 5 is mounted on the second end cover 25, and the tool body 1 is capable of being engaged with or disengaged from the elastic self-locking switch 5. The elastic self-locking switch 5 is disposed so that when the tool body 1 is not in use, the tool body 1 is inserted into the first space and engaged with the elastic self-locking switch 5, achieving a stable connection between the tool body 1 and the accessory box 2. At this time, the elastic self-locking switch 5 is in an energy storage state. When the tool body 1 needs to be used, the tool body 1 is directly pressed and pushes the elastic self-locking switch 5 to act so that the tool body 1 is disengaged from the elastic self-locking switch 5, and the tool body 1 is ejected under the action of an elastic restoring force of the elastic self-locking switch 5. The elastic self-locking switch 5 is a standard part similar to the structure of an elastic ballpoint pen, which is not described in detail here.

As shown in FIGS. 6 and 7, in some examples, a first engaging member 12 is provided at an end of the tool body 1 facing the elastic self-locking switch 5, a second engaging member 51 is movably disposed on the elastic self-locking switch 5, and the second engaging member 51 has a release position and an engaging position. When the second engaging member 51 is at the engaging position, the second engaging member 51 is engaged with the first engaging member 12. When the second engaging member 51 is at the release position, the second engaging member 51 is disengaged from the first engaging member 12, and the tool body 1 is ejectable relative to the accessory box 2. When the tool body 1 is inserted into the first space, the first engaging member 12 pushes the second engaging member 51 to move from the release position to the engaging position relative to the elastic self-locking switch 5. At this time, the elastic self-locking switch 5 is in a compressed energy storage state, and the first engaging member 12 mates with the second engaging member 51 to lock the tool body 1. When the tool body 1 needs to be taken out, the tool body 1 is pressed, and the first engaging member 12 of the tool body 1 pushes the second engaging member 51 to move from the engaging position to the release position, and the tool body 1 is ejected under the action of the elastic self-locking switch 5.

As shown in FIGS. 6 and 7, in some examples, a fixed receptacle 24 is fixedly provided in the first space of the accessory box 2. The fixed receptacle 24 is used for receiving a driving end 11 of the tool body 1, and the fixed receptacle is connected to the second end cover 25. The fixed receptacle 24 is disposed to guide and store the driving end 11 of the tool body 1 during the insertion of the tool body 1 into the first space.

In some examples, the accessory box 2 is provided with a magnetic bolt, and the magnetic bolt is coaxially disposed with the fixed receptacle 24 and located in the accessory box 2. When the tool body 1 is inserted into the first space, a mounting hole of the tool body 1 for mounting the tool accessory 4 mates with the magnetic bolt and is magnetically fixed by the magnetic bolt, further ensuring the stable fixation of the tool accessory 4. When the tool body 1 needs to be taken out from the first space, the magnetic bolt is disengaged from the mounting hole of the tool body 1 under the action of the elastic self-locking switch 5 so that the magnetic force is weakened, and the tool body 1 can be taken out.

As shown in FIG. 4, in some examples, the second space includes multiple independent storage regions 23, any one of which is capable of storing at least two tool accessories 4. The tool accessories 4 of different models and types have different dimensions. The second space is divided into multiple storage regions 23, and each storage region 23 can store at least two tool accessories 4. Thus, the tool accessories 4 are conveniently stored in the corresponding storage regions 23 according to the types and dimensions, facilitating the management and subsequent use of the tool accessories 4.

As shown in FIG. 4, in some examples, the tool accessory 4 is releasably stored in any one or a particular one of the storage regions 23 by means of magnetic fixation. The tool accessory 4 is fixed in the storage region 23 by means of magnetic attraction, which can ensure that the tool accessory 4 is stably placed in the storage region 23 and does not fall off. During the subsequent use, the user can take off the tool accessory 4 by simply overcoming the magnetic force. The tool accessory 4 may be made of a magnetic material, and a portion of the housing 3 corresponding to the storage region 23 may be made of a magnetic material. The tool accessory 4 is magnetically attracted to the storage region 23 according to the principle that opposite magnets attract each other. Of course, one of the tool accessory 4 and the housing 3 is made of a magnetic material, and the other of the tool accessory 4 and the housing 3 is made of a material that can be magnetically attracted, which can also implement the attachment and fixation function.

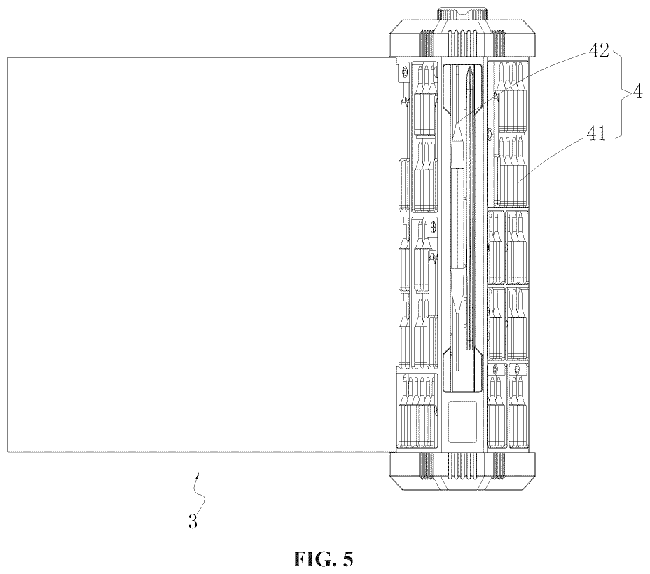

As shown in FIG. 5, in some examples, the tool accessories 4 include a bit 41 and an aiding tool 42. A combination of the bit 41 and the tool body 1 serves as a screwdriver that can loosen or tighten screws. The aiding tool 42 may be, but is not limited to, a tweezer or a clip, which can satisfy the requirement for clamping small objects at a construction site.

In some examples, the tool body 1 includes an electric screwdriver or an electric rotary grinder. The combination of the handheld tool body 1 and the bit 41 can loosen or tighten the screws, thereby increasing a speed at which the screws are mounted or detached and reducing labor intensity. A combination of the tool body 1 and a grinding head serves as the electric rotary grinder that can grind a workpiece. Of course, a cutting saw blade may be used as the tool accessory 4, and its combination with the tool body 1 serves as a cutter.

In some examples, measurement markings are provided on an inner surface of the housing 3 to form a scale. A striped surface is provided and a common scale is formed on the inner surface of the housing 3. At the construction site, the scale may be used as a measurement tool. Thus, the housing 3 can have richer functions.

As shown in FIGS. 1 to 5, the present application further provides an accessory box 2 including a first space capable of receiving a tool body 1 and a second space for releasably storing multiple tool accessories 4 adapted to the tool body 1. The accessory box 2 further includes a housing 3 including a first end having a first position and a second position. The first end moves between the first position and the second position to substantially seal or release the second space. At least part of the housing 3 is magnetic. Substantially sealing the second space means that the second space is sealed at a proportion of greater than or equal to 90 %. Specifically, the second space may be sealed at a proportion of 91%, 92%, 93%, 94%, 95%, 96%, 97%, 98%, 99%, or 100%. Substantially releasing the second space means that the second space is released at a proportion of greater than or equal to 90%. Specifically, the second space may be released at a proportion of 91%, 92%, 93%, 94%, 95%, 96%, 97%, 98%, 99%, or 100%.

The accessory box 2 is used to store the tool body 1 in the first space and the tool accessories 4 in the second space, facilitating storage, reducing an occupied space, and making it convenient to subsequently configure the tool body 1 with a corresponding tool accessory 4 for use. When the tool body 1 is not in use, the housing 3 substantially seals the second space and can prevent the tool accessories 4 from falling off. During use of a user, the housing 3 releases the second space, and the user can directly take the corresponding tool accessory 4 as required, facilitating the use of the user. When the tool accessory 4 is replaced, the tool accessory 4 may be placed and attached to the unfolded housing 3, and fasteners and the like for use in operation may also be placed and attached to the housing 3. After the completion of operation, the tool accessory 4 is directly stored in the second space, and the first end of the housing 3 is at the first position so that the second space is sealed. In this manner, the tool accessories 4 are prevented from being lost and convenient to store and carry.

In some examples, the housing 3 has a second end integrally formed with or detachably connected to a body of the accessory box 2, and the first end is an end of the housing 3 distal from the second end. The second end of the housing 3 may be integrally formed with the body of the accessory box 2, thereby saving subsequent mounting steps and ensuring that the housing 3 is stably connected to the body of the accessory box 2. Of course, the second end of the housing 3 may be designed to be engaged with, inserted into, or magnetically attracted to the body of the accessory box 2. The detachable connection enables the housing 3 to be directly replaced when the housing 3 is deformed or damaged, ensuring economy.

In some examples, the second space is disposed inside the housing 3. The housing 3 is thickened, the second space is formed inside the housing 3, and the tool accessories 4 are stored in the housing 3. When the housing 3 seals the second space, the tool accessories 4 are located between the housing 3 and the body of the accessory box 2, thereby hiding the tool accessories 4 and preventing the tool accessories 4 from falling off. When the first end of the housing 3 is at the second position, the housing 3 is unfolded and the second space is exposed, making it convenient for the user to take and use the tool accessory 4.

In some examples, the second space is disposed around the first space. Thus, the first space and the second space do not affect each other. Moreover, the space around the first space can be fully utilized, and the independent storage of the tool body 1 and the tool accessories 4 is facilitated.

As shown in FIGS. 1 to 5, the present application further provides a handheld power tool system including a tool body 1, an accessory box 2, and a housing 3.

The tool body 1 is adaptable to at least one of multiple tool accessories 4 separately. The accessory box 2 includes a first space for receiving the tool body 1 and a second space for releasably storing the multiple tool accessories 4. The housing 3 has a first state in which the housing 3 is bent to cover the second space and a second state in which the housing 3 releases at least part of the second space. At least part of the housing 3 is capable of attracting the tool accessories 4.

The accessory box 2 is used to store the tool body 1 in the first space and the tool accessories 4 in the second space, facilitating storage, reducing an occupied space, and making it convenient to subsequently configure the tool body 1 with the corresponding tool accessory 4 for use. When the handheld power tool system is not in use, the housing 3 is in the first state in which the housing 3 covers the second space so that the tool accessories 4 can be prevented from falling off. During use of a user, the housing 3 is in the second state in which the housing 3 releases at least part of the second space, and the user can directly take the corresponding tool accessory 4 as required, facilitating the use of the user. Moreover, the housing 3 has an attraction function. When the handheld power tool system is used for operation, the housing 3 can attract the replaced tool accessory 4 and screws for fastening. After the completion of operation, the tool accessory 4 is directly stored in the second space, and the housing 3 is switched from the second state to the first state. In this manner, the tool accessories 4 are prevented from being lost and convenient to store and carry.

The basic principles, main features, and advantages of the present application are shown and described above. It is to be understood by those skilled in the art that the preceding examples do not limit the present application in any form, and any technical solutions obtained through equivalent substitutions or equivalent transformations are within the scope of the present application.

What is claimed is:

1. A handheld power tool system, comprising:
a tool body adaptable to at least one of a plurality of tool accessories separately;
an accessory box comprising a first space for receiving the tool body and a second space for storing the plurality of tool accessories; and
a housing having a first state in which the housing covers the second space and a second state in which the housing releases the second space, wherein the housing comprises a first panel and a second panel; in the second state, the first panel and the second panel are capable of extending substantially coplanarly on a working plane.

2. The handheld power tool system according to claim 1, wherein in the first state, the first panel is not coplanar with the second panel.

3. The handheld power tool system according to claim 1, wherein the first panel is integrally formed with or detachably connected to the second panel.

4. The handheld power tool system according to claim 1, wherein at least part of the housing comprises a magnetic material.

5. The handheld power tool system according to claim 1, wherein the accessory box has a polygonal cross-section along a longitudinal direction.

6. The handheld power tool system according to claim 1, wherein the second space comprises a first portion and a second portion, and the first portion and the second portion are located on different sides of the accessory box.

7. The handheld power tool system according to claim 1, wherein the tool body is ejectable relative to the accessory box.

8. The handheld power tool system according to claim 7, wherein an elastic self-locking switch is provided in the first space of the accessory box, and the tool body is capable of being engaged with or disengaged from the elastic self-locking switch.

9. The handheld power tool system according to claim 8, wherein a first engaging member is provided at an end of the tool body facing the elastic self-locking switch, a second engaging member is movably disposed on the elastic self-locking switch, and the second engaging member has a release position and an engaging position; when the second engaging member is at the engaging position, the second engaging member is engaged with the first engaging member; and, when the second engaging member is at the release position, the second engaging member is disengaged from the first engaging member, and the tool body is ejectable relative to the accessory box.

10. The handheld power tool system according to claim 1, wherein a fixed receptacle is provided in the first space of the accessory box and configured to receive a driving end of the tool body.

11. The handheld power tool system according to claim 1, wherein the second space comprises a plurality of independent storage regions, any one of which is capable of storing at least two of the plurality of tool accessories.

12. The handheld power tool system according to claim 11, wherein a tool accessory of the plurality of tool accessories is releasably stored in any one or a particular one of the storage regions by means of magnetic fixation.

13. The handheld power tool system according to claim 1, wherein the plurality of tool accessories comprise a bit and an aiding tool.

14. The handheld power tool system according to claim 1, wherein the tool body comprises an electric screwdriver or an electric rotary grinder.

15. The handheld power tool system according to claim 1, wherein measurement markings are provided on an inner surface of the housing to form a scale.

16. An accessory box, comprising:
a first space capable of receiving a tool body;
a second space for releasably storing a plurality of tool accessories adapted to the tool body; and
a housing comprising a first end moveable between a first position and a second position to substantially seal or release the second space; and at least part of the housing is magnetic.

17. The accessory box according to claim 16, wherein the housing has a second end integrally formed with or detachably connected to a body of the accessory box, and the first end is an end of the housing distal from the second end.

18. A handheld power tool system, comprising:
a tool body adaptable to at least one of a plurality of tool accessories separately;
an accessory box comprising a first space for receiving the tool body and a second space for releasably storing the plurality of tool accessories; and
a housing having a first state in which the housing is bent to cover the second space and a second state in which the housing releases at least part of the second space, wherein at least part of the housing is capable of attracting the plurality of tool accessories.

19. The handheld power tool system according to claim 18, wherein the housing comprises a first panel and a second panel, and in the second state, the first panel and the second panel are capable of extending substantially coplanarly on a working plane.

20. The handheld power tool system according to claim 19, wherein in the first state, the first panel is not coplanar with the second panel.
